(19) United States
(12) Patent Application Publication
(10) Pub. No.: US 2013/0321378 A1
(43) Pub. Date: Dec. 5, 2013

(54) PIXEL LEAKAGE COMPENSATION

(71) Applicant: APPLE INC., Cupertino, CA (US)

(72) Inventors: Shafiq M. Jamal, Pleasanton, CA (US); Yafei Bi, Palo Alto, CA (US)

(73) Assignee: Apple Inc., Cupertino, CA (US)

(21) Appl. No.: 13/661,404

(22) Filed: Oct. 26, 2012

Related U.S. Application Data
(60) Provisional application No. 61/654,499, filed on Jun. 1, 2012.

(51) Int. Cl. G09G 5/00

(52) U.S. Cl. 345/212

(57) ABSTRACT

A display system has a display panel in which there are a first subset of pixels and a second subset of pixels. A first common voltage generation circuit drives a first common voltage line that is coupled to the first subset, and a second common voltage generation circuit drives a second common voltage line that is coupled to the second subset. A difference circuit has an input coupled to a first node of a pixel in the first subset, and a further input coupled to a first node of a pixel in the second subset. The difference circuit generates a sensed pixel signal difference. The second common voltage generation uses the sensed difference to compensate for pixel leakage differences between the pixels of the first and second subsets. Other embodiments are also described and claimed.

### RELATED MATTERS

This application claims the benefit of the earlier filing date of provisional application No. 61/654,499, filed Jun. 1, 2012, entitled “Pixel Leakage Compensation”.

### FIELD

An embodiment of the invention generally relates to electronic display devices and, more particularly, to active matrix thin film transistor (TFT) flat panel displays. Other embodiments are also described.

### BACKGROUND

For many applications, and particularly in consumer electronic devices, the relatively large and heavy cathode ray tube (CRT) has been replaced by flat panel display types such as liquid crystal display (LCD), plasma, electroluminescent and organic light emitting diode (OLED). Flat panel displays are typically used as video screens for a variety of consumer electronics devices, such as televisions, desktop computers and mobile or portable devices such as smart phones, digital audio and video players, video game handsets, and tablet computers. In addition to having a relatively thin profile, flat panel devices typically use less power than the CRT and are also much lighter. The flat panel display contains thousands or millions of display elements or pixels that are formed on a transparent substrate (e.g., glass), where each display element receives a data value or a signal that represents a digital picture element that is to be displayed at that location. With active matrix devices, the signal is applied using a transistor (that may be deemed part of the pixel or display element) that has been formed on the transparent substrate. These are sometimes referred to as thin film transistors (TFTs). The transistor may be driven to act as a switch element, with one carrier electrode that receives the data value, another carrier electrode that applies the data value to the pixel, and a control electrode that receives a gate or scanning signal. The gate signal may serve to modulate, typically turn on and turn off, the transistor so as to write and then store the data value into the pixel.

The array of pixels is overlaid with a grid of conductive data lines and gate lines. The data lines serve to deliver the data values to the carrier electrodes of the transistors, while the gate lines serve to apply the gate signals to the control electrodes of the transistors. In other words, each of the data lines is coupled to a respective group of pixels, typically referred to as a column, while each of the gate lines is coupled to a respective row of pixels. Each data line is coupled to a data line driver circuit that receives control and data values in digital form, from decode and timing logic that may be part of a display driver or controller-integrated circuit. The latter has translated incoming video information from another processor, including digitized pixel values, for example red, green and blue digital pixel values, into data signals having the appropriate timing and voltage and current levels. The pixel array is driven in a row-by-row or scanning line manner, where gate lines are sequentially pulsed, while during assertion of the pulse the desired pixel values are written into each selected row of pixels.

For a given pixel, the amount of light that can be viewed by the user at that point depends on the data value that has been written. Typically, a data line voltage is written as an analog pixel voltage that may be stored by a small capacitor in the pixel. In a TFT active matrix LCD pixel, the data line voltage is applied to a liquid crystal capacitor, to develop a voltage difference between a pixel electrode and a common electrode of the capacitor. This pixel voltage aligns the liquid crystal molecules that are between those electrodes in a predefined way so that light transmission is modulated at that point appropriately. This is also referred to as setting an analog voltage that represents the data value (typically, a digital gray level between white and black), into the pixel. Ideally, this written gray level should remain unchanged (as a fixed voltage across the capacitor), when the gate line pulse has ended and the transistor is turned off, until the next scan of that gate line. Unfortunately, however, each pixel suffers from leakage current, which may primarily be due to the cutoff leakage current of the transistor (TFT) in that pixel. This causes a change in the gray level at each pixel that can be apparent to a user. For example, even though a section of the display system may have been commanded to show a single color or intensity, over a number of columns, the variation in TFT-off leakage between two columns could result in a faint or slight vertical streak being apparent in an affected column. This undesirable effect may be remediated by “refreshing” the pixel many times per second, to stay closer to the initial gray level voltage that was stored across the liquid crystal capacitor. A separate storage capacitor may also be added to reduce the rate of decay of the pixel voltage. But, there are practical limitations to increasing the refresh rate and the size of the storage capacitor, to remediate the TFT-off leakage current.

### SUMMARY

An embodiment of the invention is a display system having a display panel in which the pixels are divided into first and second subsets. A first common voltage line is coupled to a first subset, while a second common voltage line is coupled to a second subset. A difference circuit is provided that has an input coupled to a first node of a pixel in the first subset, and a further input that is coupled to a first node of a pixel in the second subset. The difference circuit generates a sensed signal difference, as between the two pixels in the first and second subsets. Each of the common voltage lines is driven by its respective common voltage generation circuit. At least one of these voltage generation circuits, such as a second common voltage generation circuit that is coupled to drive the second common voltage line, has an input that is coupled to the difference circuit. This allows the second common voltage generation circuit to use the sensed signal difference to compensate for pixel leakage differences (between the two pixels of the first and second subsets). For example, by attempting to equalize the leakage in the two pixels, accuracy of the display system may be improved. In addition, such a technique may help reduce the likelihood of a vertical streak appearing on the display panel that may be due to the pixels in different columns exhibiting different levels of TFT-off leakage current. Use of the technique described here may help reduce the likelihood of such a vertical streak appearing, by compensating for the difference in TFT-off leakage currents in at least one of the affected columns.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a combined circuit schematic and block diagram of part of a display system, in accordance with an embodiment of the invention.

FIG. 2 shows example waveforms for a gate line driving signal and a data line signal, showing the effect of different transistor-off leakage between two pixels.

FIG. 3 is a combined circuit and block diagram of an example pixel signal difference measurement circuit.

FIG. 4 is a flow diagram of an example process for configuring a display system to compensate for transistor-off leakage between two pixels.

FIG. 5 shows the effect of transistor-off leakage on pixel voltage of a pair of pixels.

FIG. 6 illustrates equivalent circuit schematics of two pixels that are being equalized for transistor-off leakage.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

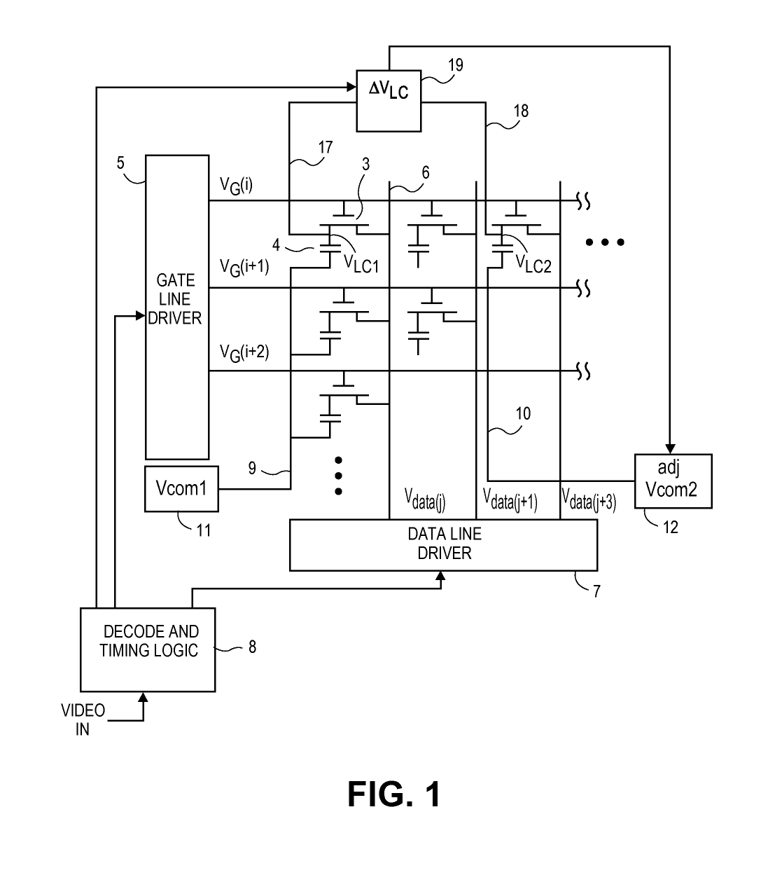

As discussed below, the present disclosure relates generally to display systems that have two or more common voltage lines. In such a display device, an array of pixels may have a first group or subset of pixels that are coupled to one common voltage, and at least another group or subset that are coupled to another common voltage, where the two common voltages will, in most instances, be set to different values. This different treatment of two or more common voltage lines is advantageously used, in accordance with an embodiment of the invention, to provide an “adjustment knob” that helps compensate or counteract the effect of imbalanced transistor-off leakage currents, in pixels of the two subsets. With this in mind, and referring now to FIG. 1, a combined circuit schematic and block diagram of an example display system or display device, in accordance with an embodiment of the invention is shown. The system has an array of display elements or pixels that form an image viewable region of a screen, for instance. Each individual pixel may include a transistor 3, e.g. a thin film transistor (TFT), that is operated as a switch, to selectively apply (turn on and turn off) a data line signal present on a data line 6 that is received on one of its carrier electrodes, on to a plate of a capacitor 4 that is connected to its other carrier electrode.

In this case, each transistor 3 of the respective pixel has its carrier electrode directly connected to a respective gate line that is driven by a voltage source V_{G}, and these voltage sources can be found within gate line driver circuitry 5. The data line signals are provided by voltage sources V_{data} that are found within data line driver circuitry 7. The data line driver circuitry 7, also called the source driver circuitry, receives control and digital pixel signals from decode and timing logic 8. The latter translates incoming digital video pixel values (for example, red, green and blue digital pixel values) into analog data signals with appropriate timing, that are then driven onto the data lines 6 by the data line driver circuitry 7. The data line driver 7 performs the needed voltage level shifting, for example, to produce a data line voltage having not just the needed fan out or current capability, but also the desired amplitude and signal swing (e.g., having the appropriate gray level voltage).

The capacitor 4 may include a liquid crystal capacitor that is formed between a pixel plate electrode (having a voltage VCL1) and a common plate or electrode, where the latter is, in this example, directly connected to a number of other pixels in the same column, by virtue of a common voltage line 9 that runs vertically as shown (similar to the data lines 6). A further capacitor (not shown), referred to as a storage capacitor, may be added to the pixel electrode, to increase the analog storage at that node. Other circuit arrangements for a storage circuit at the pixel electrode are possible.

In FIG. 1, the pixels in column j are all connected to the same common voltage line 9 that terminates at a common voltage generation source or circuit 11, which contains a variable or controllable voltage source that produces and maintains a voltage Vcom1 on the common voltage line 9. Thus, a first subset of pixels, in this example, are coupled to the common voltage line 9 at Vcom1 and are a column of pixels, namely column j. There is also a second subset of pixels, and these are connected to a second common voltage line 10 that is driven by a separately controllable common voltage generation circuit 12, which maintain a voltage Vcom2. These are the pixels in column j+3. Other pixel groupings for a common voltage generation (Vcom) circuit, such as a group consisting of one partial column and one partial row that intersects with that column, are possible. In that case, part of the common voltage line is said to run horizontally (similar to the gate lines) while part of it runs vertically.

The display system depicted in FIG. 1 has at least one pixel signal difference measurement circuit 19 (labeled ΔV_{LC}) that has one input coupled to a pixel electrode of a pixel in column j, and a further input that is coupled to a pixel electrode of a pixel in column j+3. A pair of pixel sense lines 17, 18 are provided for this coupling as shown. The measurement circuit 19 is to generate a sensed voltage difference, which may be the difference between the two pixel electrode voltages V_{LC1} and V_{LC2} through sense lines 17, 18. This difference may be performed in the analog domain, represented as an analog difference signal or value, which value is then provided to the adjust input of the second common voltage generation circuit 12 (Vcom2). The latter then uses the sensed pixel signal difference to compensate for pixel leakage differences between the pixels of the first and second subsets. For example, the adjustment performed by the second common voltage generation circuit 12 may equalize the pixel leakage in the pixels of column j with that of the pixels in column j+3. The adjustment that is performed by the voltage generation circuit 12 may encompass a change in the value of the voltage source that sets Vcom2 on the line 10, so as to counteract or compensate for the different pixel leakage levels of column j+3 and column j. This compensation or offset should be maintained so long as the display system is under normal or in-the-field use by its end user.

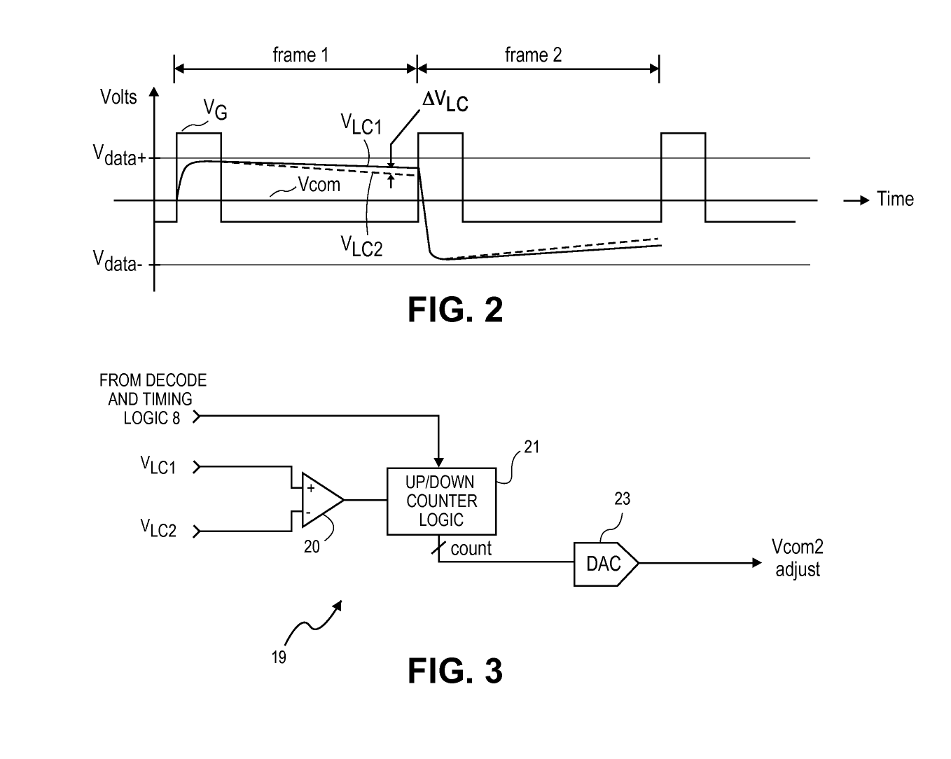

FIG. 2 shows example waveforms for a gate line driving signal and a pair of pixel signals, where the latter shows the effect of different transistor-off leakage between the two pixels. The waveforms in this figure represent the gate line voltage V_{G} (i), and the pixel electrode voltages V_{LC1} and V_{LC2} as they are shown in FIG. 1. In this case it can be seen that the gate line voltage V_{G} is applied to two pixels that are in the same row but in different columns. Also, the data line voltage V_{data} that is applied to these two pixels through their respective data lines j and j+3 (see FIG. 1) are set to the same gray level voltage. Note that FIG. 2 also shows an inversion technique at play, where the digital gray level value that is applied to the pixels is actually applied as an analog voltage (V_{data}) that alternates in polarity across successive frames, between V_{data+} and V_{data-} despite representing the same digital gray level value. That is because in the case of liquid crystal displays for which this example holds, it is desirable to have an average or dc value of zero volts across the capacitor 4 in each pixel (see FIG. 1), across several frames, in order to avoid damage to the liquid crystal structure. Thus, it should be noted that in other display technologies, this inversion may not be required such that the waveforms for V_{LC1} and V_{LC2} in FIG. 2 would not exhibit a change in polarity.

As seen in FIG. 2, because of the pixel leakage, which may be primarily due to TFT-off leakage current of the transistor 3 (see FIG. 1), the pixel electrode voltage V_{LC} decays during a frame interval, once the gate line pulse in V_{G} has ended. The difference between the two pixel electrode voltages, namely ΔV_{LC}, should be sampled some time before the end of a frame as shown, by the pixel signal difference measurement circuit 19 (see FIG. 1). This measurement or sampling may be triggered by the decode and timing logic 8 through, for example, a command from a higher layer display system monitoring process or software/firmware (not shown) that may be executing in the consumer electronic device in which the display system has been integrated.

Turning now to FIG. 3, a combined circuit schematic and block diagram of an example pixel signal difference measurement circuit 19 is shown. The circuit 19 in this case features an analog comparator 20 having a pair of complimentary inputs that are coupled to sense the pixel electrode voltages V_{LC1} and V_{LC2} (through the pixel voltage sense lines 17, 18 that are routed in the display array panel—see FIG. 1). The output of the comparator 20 controls the direction of up/down counter logic 21 whose output count is a digital value that represents the difference between the pixel voltages, ΔV_{LC}. The up/down counter logic 21 may be reset and clocked by decode and timing logic 8, and is designed to have a sufficient number of bits that can be used to adequately represent the expected range of analog voltage ΔV_{LC}. The digital count value produced by the up/down counter logic 21 in turn is converted into analog form by a digital-to-analog converter (DAC) 23, and this analog correction value is then fed to the adjust input of the second common voltage generation circuit 12, in order to adjust the common voltage Vcom2. This adjustment may be designed to counteract ΔV_{LC}, so that the decay rates of V_{LC1} and V_{LC2} (see FIG. 2) are made to be as equal as possible. This results in a counteraction to the difference between the leakage currents of the two pixels (as represented by their pixel electrode voltages V_{LC1} and V_{LC2}).

Note, however, that other ways of reporting the sensed ΔV_{LC} to the second common voltage generation circuit 12 (Vcom2) are possible. For example, the output of the up/down counter logic 21 may be simply fed as a digital count value directly to the adjust input of the second common voltage generation circuit 12, and the latter may use this digital value to perform an analog adjustment on the second common voltage line 10. Also, an alternative to sensing the pixel voltages V_{LC1} and V_{LC2} may be to actually sense a difference in the leakage currents directly, using additional circuitry such as a differential current sense amplifier that has been wired in series with each common voltage line, that is between the common voltage line 9, 10 and the respective node of the pixel to which it is connected.

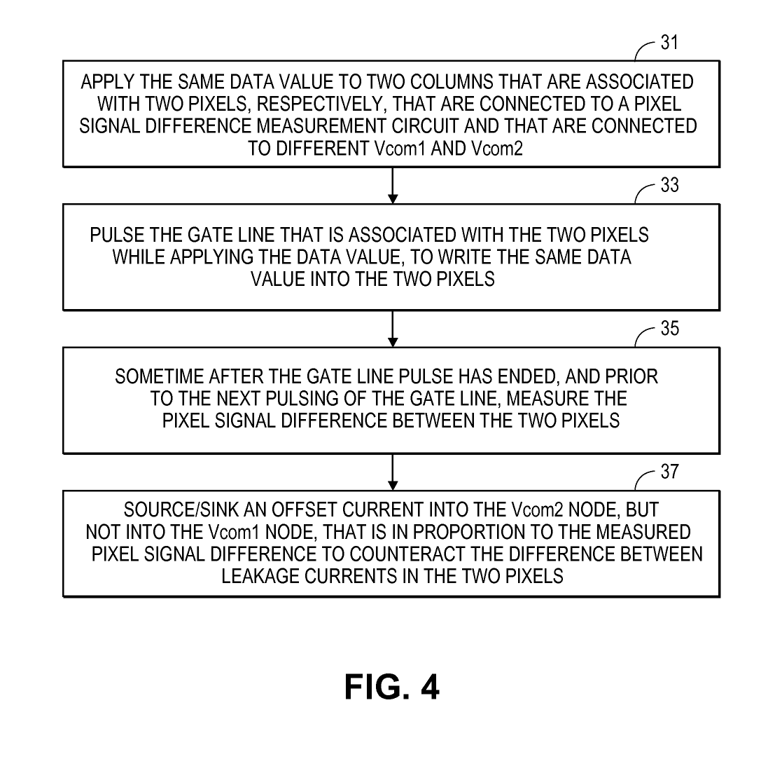

Turning now to FIG. 4, a flow diagram of an example process for configuring a display system, to compensate for transistor-off leakage between two pixels, is shown. The method may begin with writing the same data value into first and second pixels of a display panel (block 31). This may be achieved by applying the same data value to two columns (data lines) that are associated with the two pixels, respectively. Note that these are pixels which are connected to a pixel signal difference measurement circuit, such as the circuit 19 described above, and that may also be connected to different common voltages Vcom1, Vcom2. To actually write the data value into the pixels, a gate line that is associated with the two pixels may be pulsed, while applying the data value to the data lines. This results in the same written data value being stored in each of the pixels (block 33). Next, some time after the gate line pulse has ended, and prior to the next pulsing of the gate line (for example in the next frame that may be used to refresh the display panel), the pixel signal difference between the two pixels is measured (block 35). As suggested above, there may be different techniques used for doing so, including a pixel node voltage difference measurement or a direct differential leakage current measurement. Next, the common voltage line to which one of the pixels is connected is used to make an adjustment that is in proportion to the measured pixel signal difference, in order to counteract the difference between leakage currents in the two pixels (block 37). In one embodiment, an offset current is sourced or sunk into one of the common voltage lines, but not the other, so as to try and equalize the net or total leakage current in the two pixels. This embodiment will be described further below in connection with FIG. 6. In another embodiment, a variable voltage source, for example, that produces Vcom2 as part of the common voltage generation circuit 12, is adjusted so that the common voltage node of one of the pixels is adjusted in the appropriate direction, so as to bring the two pixel voltages back towards the same value that was originally written.

Now, the correction that is made in block 37 that was described above may remain in place during consecutive frames that are being written into the display panel, until a suitable time at which the leakage status of the two pixels should be reevaluated. For example, a software/firmware routine running in a display driver integrated circuit, for example, may signal that the process in FIG. 4 be repeated, for instance, once a day or less frequently or more frequently, in order to update the adjustment that is applied in block 37.

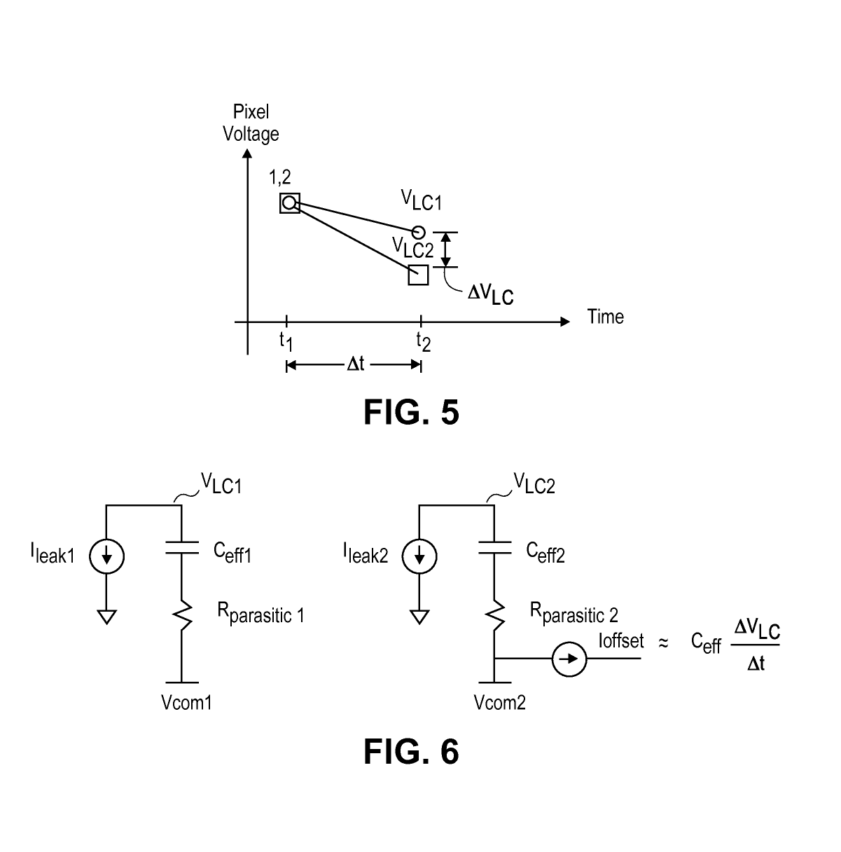

As described above, a suitable selection of at least two pixels (from the entire array of pixels that make up a display panel) is needed, for which the pixel signal differences are sensed. This sensed difference is then used to adjust voltage or current on a common voltage line that is connected to at least one of the selected pixels, so as to compensate for leakage current differences. Referring now to the waveforms in FIG. 5, the pixel signal of interest may be a pixel voltage that is stored across a small capacitor in each pixel, and where this voltage will decay at different rates (due to different leakage levels). Just as an example, such pixel voltages are referred to here as V_{LC1} and V_{LC2}, referencing a liquid crystal (LC) display cell. It should be noted, however, that the techniques described here may also be applicable to other types of active matrix display cells, and in particular, ones that operate on the basis of a pixel voltage or a pixel current that may exhibit decay due to leakage. An example here is an active matrix organic light emitting diode (AMOLED) cell.

As seen in FIG. 5, after a suitable time interval At has elapsed, a sample is taken of the sensed difference in the two voltages, labeled here as ΔV_{LC}. In one embodiment, an offset current is then produced that is in proportion to the sensed voltage difference. The value of the offset current may be computed by a display calibration or test procedure running on a processor that may be part of a display driver integrated circuit (not shown.) The approach given in FIG. 6 may be used to compute the offset current. To explain this approach, FIG. 6 illustrates the equivalent circuit schematics for the two pixels of interest, where, in principle, each pixel may have a slightly different charge storage capacitance, C_{eff1} and C_{eff2}, and a different parasitic resistance between the pixel node (a plate of C_{eff1}, C_{eff2}) and the common voltage generation circuit Vcom1, Vcom2. Of course, each pixel will likely have different leakage currents Iₗₑₐₖ₁, Iₗₑₐₖ₂. Now, as an approximation, it may be assumed that C_{eff} and R_{parasitic} are about the same between the two pixels, at least at the relatively small levels of Iₗₑₐₖ₁, Iₗₑₐₖ₂. With that assumption, it can be seen that I_{offset}≈Iₗₑₐₖ₁−Iₗₑₐₖ₂ may be defined as shown. This allows actual or current knowledge of ΔV_{LC} (obtained through measurements made in-the-field), and pre-existing knowledge of the effective charge storage capability C_{eff}≈C_{eff1}≈C_{eff2} (obtained through laboratory measurements), and of the measurement interval Δt, to be used for computing an offset current I_{offset} which is in proportion to ΔV_{LC} (in accordance with the formula shown in FIG. 6).

In one embodiment, the offset current I_{offset} can be readily determined based on the measured value of ΔV_{LC}, and it may be assumed that Δt and C_{eff} essentially do not change since the time when the display panel was manufactured. In other words, during manufacturing test, statistical analysis of measurements collected from production specimens of the display system can generate a value for C_{eff}. In addition, a suitable value for Δt is selected that allows enough decay of the pixel signals so that ΔV_{LC} can be accurately sensed (by the measurement circuit 19—see for example FIG. 3). In that case, the measured pixel signal difference ΔV_{LC} is sufficient to digitally compute, or alternatively formulate using an analog circuit, the offset current I_{offset}, each time ΔV_{LC} is sampled during in-the-field use.

Thus, the arrangement depicted in FIG. 1 is able to correct for pixel leakage differences between two subsets of pixels, using integrated circuitry that can detect a measure of the difference in pixel leakage between two selected pixels that may have been hardwired at the factory to separate pixel sense lines 17, 18. The circuitry is then able to compensate for the detected pixel leakage imbalance as the display ages or undergoes variations during in-the-field use, without having to return the display system to its manufacturer for testing or calibration. While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, although the discussion above refers to a single transistor (being a TFT) as the switch element of a pixel, the discussion is also applicable to the case where the switch element is a different active device or has a more complex circuit structure (e.g., more than transistor). The description is thus to be regarded as illustrative instead of limiting.

What is claimed is:

1. A display system comprising:
a display panel having a plurality of pixels;
a first common voltage line coupled to a first subset of the pixels, and a second common voltage line coupled to a second subset of the pixels;
a difference circuit having an input coupled to a first node of a pixel in the first subset, and a further input coupled to a first node of a pixel in the second subset, the difference circuit to generate a sensed pixel signal difference;
a first common voltage generation circuit to drive the first common voltage line; and
a second common voltage generation circuit to drive the second common voltage line, wherein the second common voltage generation circuit has an input that is coupled to the difference circuit to use the sensed pixel signal difference to compensate for pixel leakage differences between the pixels of the first and second subsets.

2. The display system of claim 1 wherein the sensed pixel signal difference is an analog voltage difference between a) the first node of the pixel in the first subset and b) the first node of the pixel in the second subset.

3. The display system of claim 1 wherein the difference circuit comprises a comparator having inputs that are coupled to a) the first node of the pixel in the first subset and b) the first node of the pixel in the second subset.

4. The display system of claim 1 wherein the first and second common voltage generation circuits have variable voltage sources that can set and maintain the first and second common voltage lines at different dc voltages, respectively, during each frame interval in which the pixels of the display panel are refreshed.

5. The display system of claim 2 wherein the first and second common voltage generation circuits have variable voltage sources that can set and maintain the first and second common voltage lines at different dc voltages, respectively, during each frame interval in which the pixels of the display panel are refreshed.

6. The display system of claim 3 wherein the first and second common voltage generation circuits have variable voltage sources that can set and maintain the first and second common voltage lines at different dc voltages, respectively, during each frame interval in which the pixels of the display panel are refreshed.

7. The display system of any one of claims 1 wherein the first and second common voltage lines are directly connected to respective second nodes of the pixel in the first subset and the pixel in the second subset.

8. The display system of claim 2 wherein the first and second common voltage lines are directly connected to respective second nodes of the pixel in the first subset and the pixel in the second subset.

9. The display system of claim 3 wherein the first and second common voltage lines are directly connected to respective second nodes of the pixel in the first subset and the pixel in the second subset.

10. The display system of claim 7 wherein the second generation circuit is to generate an offset current in the second node of the pixel in the second subset, relative to the second node of the pixel in the first subset, that is in proportion to the sensed pixel signal difference.

11. A display circuit for driving a display panel, comprising:
means for displaying a digital image;
means for sensing a signal difference between first and second pixels of said display means;
first means for driving a node of the first pixel at a first common voltage; and
second means for driving a node of the second pixel at a second common voltage, said second driving means to use the sensed signal difference for further driving the node of the second pixel so as to counteract a difference between leakage currents in the first and second pixels.

12. A method for driving a display panel, comprising:
a) writing the same data value into first and second pixels of a display panel;
b) measuring a pixel signal difference of the first and second pixels, while the pixels are storing the written data value; and
c) generating an adjustment to the second pixel but not the first pixel that is in proportion to the measured pixel signal difference.

13. The method of claim 12 wherein said writing the same data value to the first and second pixels comprises applying the same data value to two columns associated with the first and second pixels, respectively, while pulsing a gate line associated with the first and second pixels.

14. The method of claim 13 wherein said measuring a pixel signal difference comprises producing an analog or digital value that represents a pixel voltage difference between the first and second pixels at some time after the pulsing of the gate line and before a subsequent pulsing of the gate line.

15. The method of claim 13 wherein said measuring a pixel signal difference comprises sensing a leakage current difference between the first and second pixels.

16. The method of claim 12 wherein said generating an adjustment comprises producing an offset current into a common voltage node of the second pixel but not the first pixel that is in proportion to the measured pixel signal difference.

17. The method of claim 13 wherein said generating an adjustment comprises producing an offset current into a common voltage node of the second pixel but not the first pixel that is in proportion to the measured pixel signal difference.

18. The method of claim 14 wherein said generating an adjustment comprises producing an offset current into a common voltage node of the second pixel but not the first pixel that is in proportion to the measured pixel signal difference.
